(19) United States
(12) Patent Application Publication
(10) Pub. No.: US 2012/0257490 A1
(43) Pub. Date: Oct. 11, 2012

(54) Gratings For Waveguide Coupling

(75) Inventor: Lifu Zhou, Eden Prairie, MN (US)

(73) Assignee: SEAGATE TECHNOLOGY LLC, Scotts Valley, CA (US)

(21) Appl. No.: 13/081,547

(22) Filed: Apr. 7, 2011

(51) Int. Cl. G11B 7/00; C23F 1/00; G02B 6/34

(52) U.S. Cl. 369/121; 385/37; 369/100; 216/24; G9B/7

(57) ABSTRACT

An apparatus includes a waveguide including a core layer and first and second cladding layers positioned on opposite sides of the core layer, a plurality of slots extending through the core layer and into the first and second cladding layers, a filler material in the slots, wherein the core has a first refractive index, the cladding layers have a second refractive index lower than the first refractive index, and the filler material has a third refractive index between the first and second refractive indices, and a light source positioned to direct light onto the slots. A data storage device that includes the apparatus is also provided.

### BACKGROUND

Heat assisted magnetic recording (HAMR) generally refers to the concept of locally heating recording media to reduce the coercivity of the media so that the applied magnetic writing field can more easily direct the magnetization of the media during the temporary magnetic softening of the media caused by the heat source. A tightly confined, high power light spot is used to heat a portion of the recording media to substantially reduce the coercivity of the heated portion. Then the heated portion is subjected to a magnetic field that sets the direction of magnetization of the heated portion. In this manner the coercivity of the media at ambient temperature can be much higher than the coercivity during recording, thereby enabling stability of the recorded bits at much higher storage densities and with much smaller bit cells. Heat assisted magnetic recording is also referred to a thermally assisted magnetic recording.

The recording media may be heated using a light beam generated by a laser diode and coupled into the recording head. Because the waveguide structure inside the laser diode is quite different from the guiding structure inside the recording head, challenges exist in establishing an efficient, reliable and low cost design for coupling the output of the laser diode to the recording head.

Similar issues exist in the area of optical communication and information processing, for example, when coupling light from a laser diode into a single mode optical fiber or into a channel waveguide in a planar optical circuit. There are two major categories of solutions to the problem: to use a grating or end firing. Canonical linear grating couplers require a collimated incident beam so extra lenses are necessary. The position and direction of the collimating lens need to be controlled precisely as the coupling efficiency is very sensitive to the incident angle. A curved grating can couple light into a planar waveguide from a point source, but the positioning accuracy requirement for the laser diode is not relaxed. In the end firing scenario, the lateral alignment accuracy of two waveguides should be a small fraction of the mode width. Since the laser diode may be about 1 micrometer wide, positioning the laser diode chip in a large volume structure at submicron accuracy is difficult.

It is desirable to launch light into a waveguide with a high light delivery efficiency.

### SUMMARY

In one aspect, the disclosure provides an apparatus including a waveguide having a core layer and first and second cladding layers positioned on opposite sides of the core layer, a plurality of slots extending through the core layer and into the first and second cladding layers, a filler material in the slots, wherein the core has a first refractive index, the cladding layers have a second refractive index lower than the first refractive index, and the filler material has a third refractive index between the first and second refractive indices, and a light source positioned to direct light onto the slots.

These and other features and advantages which characterize the various embodiments of the present disclosure can be understood in view of the following detailed description and the accompanying drawings.

### BRIEF DESCRIPTION OF THE DRAWINGS

FIG. 1 is a schematic representation of a laser and waveguide assembly.

FIG. 2A is a cross-sectional view of a portion of the waveguide in the assembly of FIG. 1.

FIG. 2B is a cross-sectional view of a portion of another waveguide that can be used in the assembly of FIG. 1.

FIGS. 3 and 4 are cross-sectional views of intermediate structures used in the fabrication of the grating coupler of FIG. 2A.

FIG. 5 is a cross-sectional view of a portion of another laser and waveguide assembly.

FIG. 6 is a plan view of a portion of the waveguide of the assembly of FIG. 5.

FIG. 7 is a cross-sectional view of a recording head.

FIG. 8 is a pictorial representation of a data storage device in the form of a disc drive that can include a transducer in accordance with an aspect of this disclosure.

### DETAILED DESCRIPTION

In one aspect, this disclosure provides a slanted grating to couple a wide aperture VCSEL output into thin planar waveguides. The grating can be configured to separate the perturbation part of the grating from the guiding parts of the grating. The grating includes a plurality of slots passing through a core layer in the planar waveguide. As used in this description, the perturbation part is a filler material in the slots, and the guiding parts are the remaining parts of the core layer.

When known gratings with vertical grating lines are used to couple light into a planar waveguide, the grating couples light equally in opposite directions in the waveguide, e.g., to the left and right of the grating. Thus the intensity of the coupled light in the desired direction is about ¼ of the maximum possible value. It would be desirable to provide a grating that can couple light preferentially into one direction only. To make the grating lines differentiate different directions, relatively thick grating lines are desirable. In addition, to make a grating having an adjustable scattering strength, it is desirable to have some flexibility in the choice of the refractive index difference of the materials in the grating region.

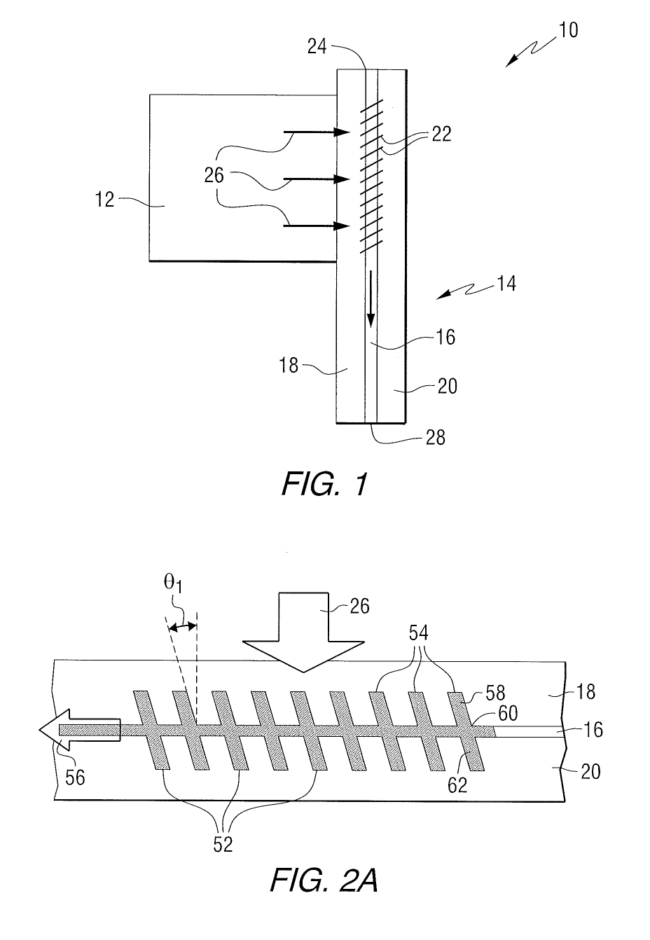

FIG. 1 is a schematic representation of a laser and waveguide assembly 10 in accordance with an embodiment of the disclosure. The assembly includes a laser 12, which can be for example a vertical cavity surface emitting laser (VCSEL) or another type of laser or source of electromagnetic radiation, positioned adjacent to a planar waveguide 14. In this description electromagnetic radiation, which can be for example visible, infrared, or ultraviolet light, is generically referred to as light.

The waveguide includes a core layer 16 between first and second cladding layers 18 and 20. A grating 22 includes elements that pass through the core guiding layer and extend into the first and second cladding layers. The grating elements are tilted with respect to the plane of the core guiding layer. Light indicated by arrows 26 is directed onto the grating and coupled into the waveguide. The waveguide can include shaped edges (e.g., in front of and behind the plane of the figure) to focus the light to a focal point adjacent to an end 28 of the waveguide. When used in a recording head, the waveguide can form a planar solid immersion mirror with the end 28 positioned adjacent to an air bearing surface of a slider.

Vertical cavity surface emitting lasers (VCSELs) are a type of semiconductor laser in which light is emitted out of a typically circular aperture at either the top or bottom of the device instead of the side as is done with edge-emitting lasers. The geometry of VCSELs reduces manufacturing costs, increases yield and has a number of other advantages including a narrower line width, no astigmatism, reduced sensitivity to feedback noise, etc. A VCSEL can be placed directly over the grating. However, while the laser in FIG. 1 is shown to be directly adjacent to the waveguide, it should be understood that such relative placement is not required. In addition, other light sources and/or other means for directing light onto the grating are also encompassed by the disclosure. For example a light source may be located away from the waveguide and the light may be directed along a path toward the waveguide, wherein the path includes other optical components such as lenses or fiber optics.

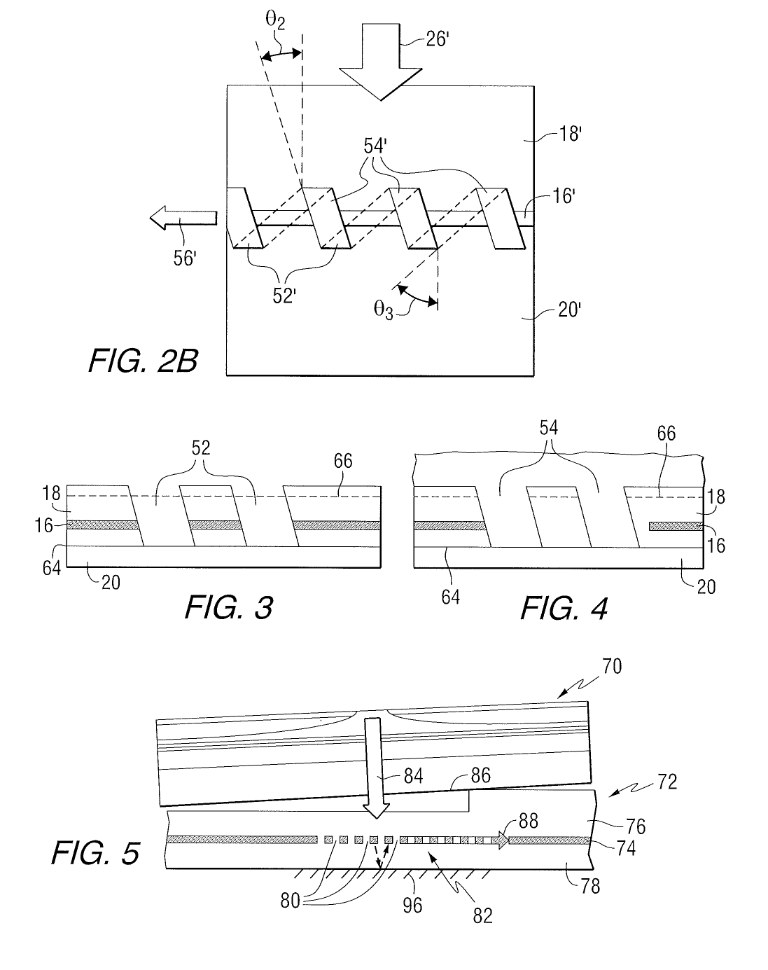

FIG. 2A is a cross-sectional view of a portion of the waveguide in the assembly of FIG. 1. The waveguide includes a core layer 16 between first and second cladding layers 18 and 20. A grating is formed by a plurality of slanted elements 52 that extend through the core layer and into the first and second cladding layers. The elements comprise a filler material 54 positioned in slanted slots. Light indicated by arrow 26 is directed onto the grating and coupled into the waveguide as shown by arrow 56. The slots are tilted with respect to a plane of the core at an angle θ₁ in the range of from 0° to about 30°. If the slots are oriented at a 0° angle, then light would couple into the core equally in both directions, but a tilted light mount can be used to provide direction control as shown in FIG. 5. A common feature between zero degree slot and slanted slot embodiments is the etched through feature, which greatly improves the uniformity of grating structure. By controlling the slot angle and slot size, the grating can be optimized for different VCSEL aperture sizes.

The slanted grating of FIG. 2A can be considered to be three gratings shifted horizontally and stacked vertically. When viewed in this manner, the slanted grating elements in the cladding layer 18 form a first grating 58, the slanted grating elements in the core layer 16 form a second grating 60, and the slanted grating elements in the cladding layer 20 form a third grating 62.

FIG. 2B is a cross-sectional view of a portion of another waveguide that can be used in the assembly of FIG. 1. The waveguide includes a core layer 16′ between first and second cladding layers 18′ and 20′. A grating 22′ is formed by a plurality of slanted elements 52′ that extend through the core layer and into the first and second cladding layers. The elements comprise a filler material 54′ positioned in slanted slots. Light indicated by arrow 26′ is directed onto the grating and coupled into the waveguide as shown by arrow 56′. The slots are tilted with respect to a plane of the core at an angle θ₁ in the range of from 0° to 30°.

As indicated in FIG. 2B, the filler material is positioned in slanted slots that pass through the core layer and extend into the cladding layers. The slanted slots are shown to be tilted to the left at an angle of θ₂, but because of the relative refractive indexes of the filler, the core and the cladding layer, the high/low index interface is aligned in the direction of the dotted lines, which are tilted to the right at an angle of θ₃. The tilt direction of those effective slots is such that the light is coupled into the core layer in the direction indicated by arrow 56. With this structure, the geometric tilt of the filler is much smaller than the effective slant angle.

In the waveguides illustrated in FIGS. 2A and 2B, the filler material can have a refractive index different from the cladding material. In one embodiment, the core has a first refractive index, the cladding layers have a second refractive index lower than the first refractive index, and the filler material has a third refractive index between the first and second refractive indices. For one specific example, the incident light comes from a substantially normal direction with respect to the core layer in the waveguide, the refractive index of the waveguide core is 2.08, the refractive index of the cladding is 1.5, and the refractive index of the filler material is 1.8.

The core can be made of for example, Si, Si₃N₄, TiO₂ or Ta₂O₅. The first and second cladding layers can be made of, for example, Al₂O₃, SiO₂, MgO or polymers. The filler material can be, for example, Al₂O₃, SiO₂ or a material with tunable index like SiOₓN_{y}.

In one aspect of the disclosure, a slanted grating is used to couple normal incident light to one direction only. To do that, the thickness of the grating lines, measured in a direction perpendicular to the plane of the waveguide, need to be comparable or larger than a half wavelength of the light incident upon the grating.

For the design in FIGS. 2A and 2B, it is desired to have the thickness of the filler in the top and bottom cladding layers be equal if the two claddings are the same material. The width/line width of the slanted elements can be used to fine tune the coupling distance when a larger or smaller VCSEL aperture size is used. Numerical analysis such as, for example, a finite-difference time-domain (FDTD) method or a finite element method (FEM) can be used to determine the filler material index, thickness and slant angle. Taking the grating in FIGS. 2A and 2B as an example, the optimal angle θ for normal incident light having a wavelength of 980 nm is 17.5°, while the coupled light propagates to the left.

FIGS. 2A and 2B show an etched through grating, wherein the core layer of the planar waveguide is etched all the way through. This is possible because the grating period for close to normal incident light is approximately equal to the effective wavelength in the guided mode, and it is slightly smaller than the wavelength in the cladding layer.

With an etched through grating, the effective mode index doesn't depend on etch ending time. Additionally, the core layer thickness has a smaller impact on the effective mode index. For a waveguide, the sensitivity of mode index on core layer thickness depends on the index contrast of the core and cladding. For an etched through grating, the effective core is a mix of the core material and the cladding material, and thus has a smaller index contrast compared with previous waveguides.

The grating can be made by a method described with reference to FIGS. 3 and 4. FIGS. 3 and 4 are cross-sectional views of intermediate structures used in the fabrication of the grating coupler of FIGS. 2A and 2B.

FIG. 3 shows a thin film structure having a core layer 16, with cladding layers 18 and 20 on opposite sides of the core. Tilted slots 52 have been etched through the core 16 and cladding layer 18, and into cladding layer 20. Line 64 under the core layer indicates an optional etch stop layer. Whether the etch stop layer is needed depends on the availability of materials that have similar refractive index as the cladding layer but with a much slower etching rate. Unlike regular gratings, the grating patterning is on top of the cladding layer, not on top of the core layer.

In the intermediate structures of FIGS. 3 and 4, the thickness of the top cladding layer is larger than the final top surface of the filler material, as indicated by the dashed line 66. After grating etching, the grooves are filled. The filling process is desired to be conformal, i.e., the filler material conforms to the sides of the slots.

Additional grazing angle etching may be used between the coating steps to further reduce rippling on top of the filler material. After coating/filling, chemical mechanical polishing (CMP) can be used to remove the excess filler material and to set the grating line height to the desired value.

The gratings described above can be used in the light delivery system in heat assisted magnetic recording heads. They can also be used in other applications that need coupling between two waveguides such as in waveguide couplers for optical communications, or when coupling an optical fiber to a laser diode.

FIG. 5 is a cross-sectional view of a laser and waveguide assembly in accordance with another aspect of the disclosure. A laser diode 70 is positioned adjacent to a planar waveguide 72. The planar waveguide includes a core layer 74 and cladding layers 76 and 78 on opposite sides of the core layer. A plurality of slots 80 pass through the core layer and are filled with a filler material similar to that of the cladding layers.

The filled slots form a coupling grating 82. Light 84 from the laser, which may be a VCSEL, impinges on the coupling grating. The output facet 86 of the laser is tilted with respect to the core layer of the waveguide. Some of the light is coupled into the waveguide core. Light that passes through the coupling grating strikes a reflective surface 96 and is reflected back to the coupling grating. Eventually, most of the laser light is coupled into the core layer and propagates to the right as shown by arrow 88. The VCSEL is tilt mounted on the waveguide to provide preferred directional coupling, and to prevent reflected light from interfering with the coupled light. The VCSEL can be tilted with respect to a direction normal to the plane of the core at an angle θ in the range of from about 2° to about 5°. A smaller angle is easier to fabricate. The minimum angle depends on the numerical aperture of the VCSEL aperture. A good estimation of the least tilt angle is: 57 times the wavelength/aperture diameter. Then for example, for a 980 nm VCSEL with a 35 micron aperture, the angle should be larger than 1.6 degrees.

In FIG. 5, the two sides of the VCSEL are mounted at different distances from the grating surface thus the VCSEL makes a small angle from the surface normal. This tilt angle is selected so that (1) the grating has a preferred direction of coupling, depending on the grating period; and (2) the light not coupled into the grating and reflected by the VCSEL surface takes an angle that won't couple into the grating efficiently. Beneath the grating, there may be a high reflectivity mirror 96 to improve the overall grating efficiency.

An example design for an etched through grating used with light having a wavelength of 980 nm has the following parameters.

| | |
|---|---|
| Grating Period | 0.592 μm |
| Bottom Cladding thickness | 0.570 μm |
| Line Width | 0.296 μm |
| Line Depth | Through |
| Core Thickness | 0.130 μm |
| Core Index | 2.093 μm |
| Cladding Index | 1.634 μm |
| Incident angle | 1.61° in air |

For the example design, the core layer thickness tolerance is 10 times that of a previously known grating for the same purpose, and there is no critical etching, for this example, the filler thickness measured in a direction perpendicular to the plane of the waveguide can change up to about 50 nm without hurting the coupling efficiency.

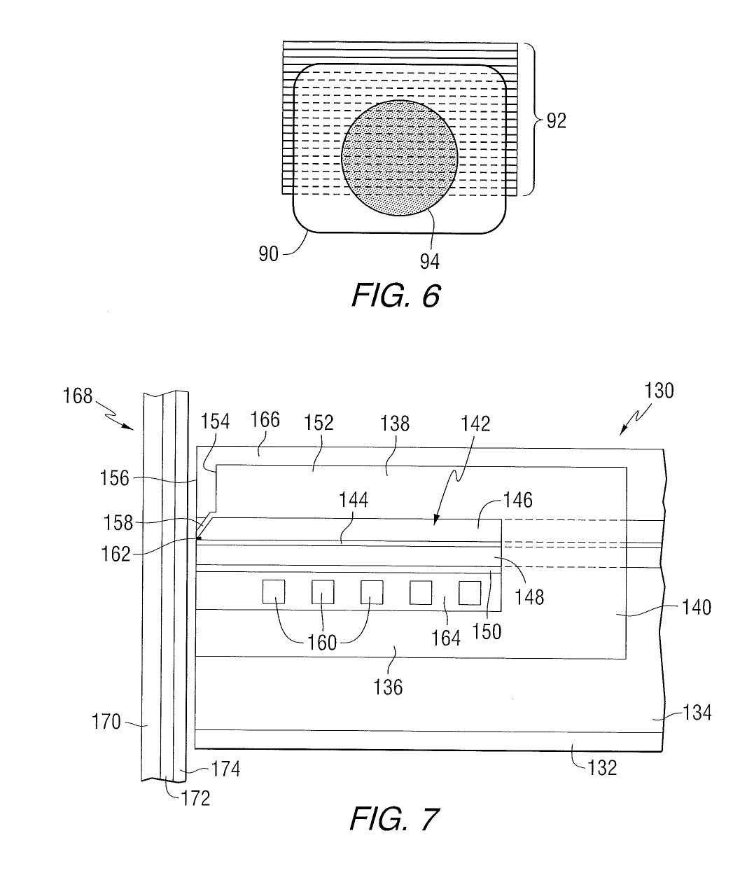

One issue for the etched through grating relates to adjusting the optimized coupling distance. It is well known that for a grating to achieve the highest coupling efficiency, the coupling distance (i.e., the length of the overlap between the input spot and the grating area) should be about 1.2α, where α is the decay distance of the guided mode that one wants to launch in the grating. FIG. 6 is a top view of a portion of a laser coupling assembly showing only a VCSEL 90 and the grating area 92. The output aperture of the VCSEL is indicated by the circle 94. The grating area is shown as a horizontal grid. FIG. 6 is not to scale and is only illustrative of an overlap between a laser spot and a grating.

If the VCSEL aperture size cannot be adjusted, the decay distance of the grating needs to be adjusted to get the highest coupling efficiency. To address this issue, one can change the thickness of the core in the grating area, or adjust the input aperture size to match the grating. Alternatively, one can use the design shown in FIG. 5 if neither the core thickness nor the input spot can be changed.

When the example of FIG. 5 is used in a date storage device, the VCSEL diode laser is tilt mounted on the recording head to provide preferred directional coupling, and to prevent reflected light from interfering with the coupled light. The grating in the recording head is etched through to remove dependence of the coupling angle on the etch depth. This is important for a fixed angle of incidence application. The etched through feature also alleviates the requirements on guiding layer thickness and refractive index control.

A refill method can be used to increase the spot size flexibility of the described etched through grating. With a refill method, one can change the material in the gap of a etched through grating to change the decay distance of the grating. By default the filler material can be the same as the cladding material. But in an alternative embodiment, one can use different filler if the cladding material must be fixed but doesn't allow high efficiency coupling. In one example, the gap in the core area filled with cladding material is filled with a new material with different refractive index. A lower refractive index material can be used as the filling material if the input spot size needs to be made smaller, and vice versa.

FIG. 7 is a cross-sectional view of an example of a recording head for use in heat assisted magnetic recording. The recording head 130 includes a substrate 132, a base coat 134 on the substrate, a bottom pole 136 on the base coat, and a top pole 138 that is magnetically coupled to the bottom pole through a yoke or pedestal 140. A waveguide 142 is positioned between the top and bottom poles. The waveguide includes a core layer 144 and cladding layers 146 and 148 on opposite sides of the core layer. A mirror 150 is positioned adjacent to one of the cladding layers. The top pole is a two-piece pole that includes a first portion, or pole body 152, having a first end 154 that is spaced from the air bearing surface 156, and a second portion, or sloped pole piece 158, extending from the first portion and tilted in a direction toward the bottom pole. The second portion is structured to include an end adjacent to the air bearing surface 156 of the recording head, with the end being closer to the waveguide than the first portion of the top pole. A planar coil 160 also extends between the top and bottom poles and around the pedestal. A near-field transducer (NFT) 162 is positioned in the cladding layer 46 adjacent to the air bearing surface. An insulating material 164 separates the coil turns. Another layer of insulating material 166 is positioned adjacent to the top pole.

A recording medium 168 is positioned adjacent to or under the recording head 130. The recording medium 168 in this example includes a substrate 170, a soft magnetic underlayer 172 is deposited on the substrate 170, and a hard magnetic recording layer 174 is deposited on the soft underlayer 172.

The optical waveguide acts in association with a source of electromagnetic radiation (such as the laser diodes shown in FIGS. 1 and 5) which transmits electromagnetic radiation to the waveguide. The light is coupled to the optical waveguide by a grating as shown in FIG. 1 or 5. The light propagates through the optical waveguide toward the recording medium to heat a localized area of the recording layer. Although the recording head may be a perpendicular magnetic recording head and the storage medium may be a perpendicular magnetic recording medium, it will be appreciated that the disclosure may also be used in conjunction with other types of recording heads and/or recording mediums where it may be desirable to employ heat assisted recording.

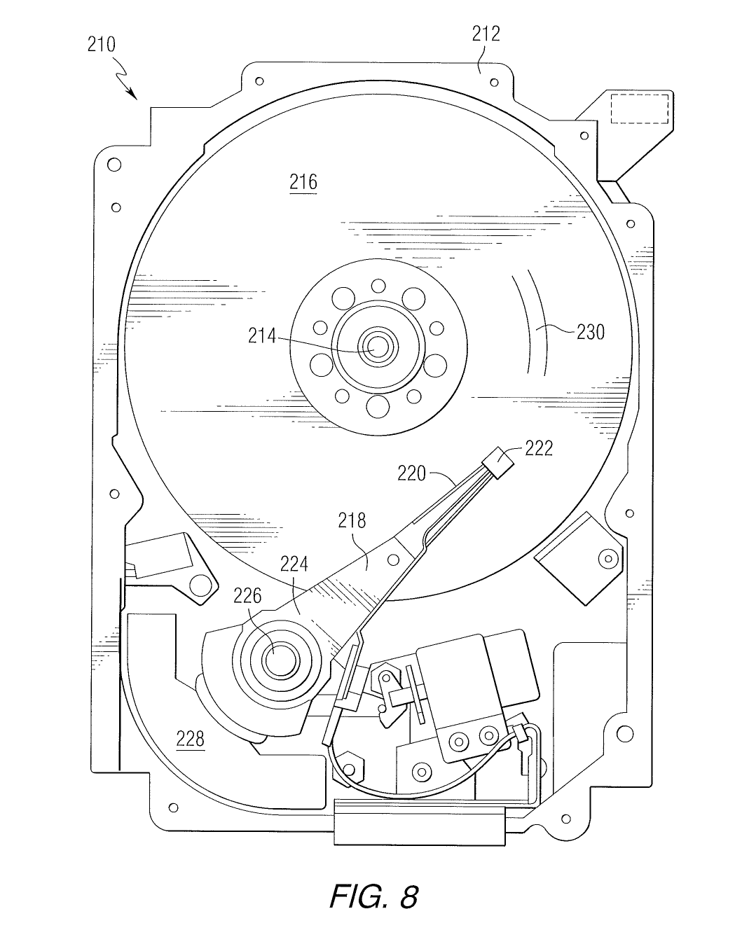

In one aspect, the disclosure provides an apparatus including a storage medium; a recording head including a waveguide and a grating coupler as described above, and an arm for positioning the recording head adjacent to the storage medium. For example, the recording head of FIG. 7 can be included in a data storage device, such as that illustrated in FIG. 8. FIG. 8 is a pictorial representation of a magnetic storage device in the form of a disc drive that can include a recording head constructed in accordance with the disclosure. The disc drive 210 includes a housing 212 (with the upper portion removed and the lower portion visible in this view) sized and configured to contain the various components of the disc drive. The disc drive 210 includes a spindle motor 214 for rotating at least one storage medium 216. At least one arm 218 is contained within the housing 212, with each arm 218 having a first end 220 with a recording head or slider 222, and a second end 224 pivotally mounted on a shaft by a bearing 226. An actuator motor 228 is located at the arm's second end 224 for pivoting the arm 218 to position the recording head 222 over a desired sector or track 230 of the disc 216.

In another aspect the disclosure provides a method for fabricating a waveguide with a grating coupler including: providing a thin film structure having a core layer having a first refractive index and first and second cladding layers having a second refractive index on opposite sides of the core layer, etching tilted slots through the core layer and the first cladding layer, and into the second cladding layer, and filling the slots with a filler material having a third refractive index between the first and second refractive indices. The second cladding layer can include an etch stop layer.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

What is claimed is:

1. An apparatus comprising:
a waveguide including a core layer and first and second cladding layers positioned on opposite sides of the core layer;
a plurality of slots extending through the core layer and into the first and second cladding layers;
a filler material in the slots, wherein the core has a first refractive index, the cladding layers have a second refractive index lower than the first refractive index, and the filler material has a third refractive index between the first and second refractive indices; and
a light source positioned to direct light onto the slots.

2. The apparatus of claim 1, wherein the slots are tilted with respect to a plane of the core at an angle in the range of from 0° to about 30°.

3. The apparatus of claim 1, wherein the slots are tilted with respect to a plane of the core and the light strikes the slots from a direction substantially normal to the plane of the core layer.

4. The apparatus of claim 1, wherein the light source comprises a vertical cavity surface emitting laser.

5. The apparatus of claim 1, wherein the core comprises a material selected from the group of:
Si, Si₃N₄, TiO₂ or Ta₂O₅.

6. The apparatus of claim 1, wherein the first and second claddings comprise a material selected from the group of:
Al₂O₃, SiO₂, MgO or a polymer.

7. The apparatus of claim 1, wherein the filler material comprises a material selected from the group of:
Al₂O₃, SiO₂ or SiOₓN_{y}.

8. The apparatus of claim 1, wherein the light source is positioned to direct light onto the slots at a non-normal angle.

9. The apparatus of claim 8, wherein the light source is positioned to direct light onto the grating at an angle in the range of from about 2° to about 5°.

10. The apparatus of claim 8, further comprising a reflective surface for directing reflected light toward the core layer.

11. An apparatus comprising:
a storage medium;
a recording head including a waveguide including a core layer and first and second cladding layers positioned on opposite sides of the core layer, a plurality of slots extending through the core layer and into the first and second cladding layers, a filler material in the slots, wherein the core has a first refractive index, the cladding layers have a second refractive index lower than the first refractive index, and the filler material has a third refractive index between the first and second refractive indices, and a light source positioned to direct light onto the slots; and
an arm for positioning the recording head adjacent to the storage medium.

12. The apparatus of claim 11, wherein the slots are tilted with respect to a plane of the core at an angle in the range of from 0° to about 30°.

13. The apparatus of claim 11, wherein the slots are tilted with respect to a plane of the core and the light strikes the slots from a direction substantially normal to the plane of the core layer.

14. The apparatus of claim 11, wherein the light source comprises a vertical cavity surface emitting laser.

15. The apparatus of claim 11, wherein the light source is positioned to direct light onto the slots at a non-normal angle.

16. The apparatus of claim 15, wherein the light source is positioned to direct light onto the grating at an angle in the range of from about 2° to about 5°.

17. The apparatus of claim 15, wherein further comprising a reflective surface for directing reflected light toward the core layer.

18. A method comprising:
providing a thin film structure having a core layer having a first refractive index and first and second cladding layers having a second refractive index on opposite sides of the core layer;
etching tilted slots through the core layer and the first cladding layer, and into the second cladding layer; and
filling the slots with a filler material having a third refractive index between the first and second refractive indices.

19. The method of claim 18, wherein the second cladding layer includes an etch stop layer.

20. The method of claim 18, further comprising:
polishing the thin film structure to remove a portion of the filler material and to set a grating line height to a desired value.
